(19) United States
(12) Patent Application Publication
(10) Pub. No.: US 2011/0259174 A1
(43) Pub. Date: Oct. 27, 2011

(54) CARRIER FOR PERCUSSION INSTRUMENTS

(76) Inventors: Rodney Arcaro, Delaware, OH (US); Dave Clark, Burlington, WI (US)

(21) Appl. No.: 12/974,651

(22) Filed: Dec. 21, 2010

Related U.S. Application Data
(60) Provisional application No. 61/288,650, filed on Dec. 21, 2009.

(51) Int. Cl. G10D 13/02

(52) U.S. Cl. 84/421

(57) ABSTRACT

A carrier for use by a person to carry a device extending outwardly from said person. The carrier preferably having an abdominal plate with a pair of support members extending from the abdominal plate, around the waistline of the person, continuing up the back and along the thoracic portion of the person's back, and stopping on the top portion of the trapezius muscle of the person. One or both support members may be detachable from the abdominal plate. Alternatively, one or both support members may rotate relative to the abdominal plate. Adjustment points may be placed on the support members to allow for the members to be sized appropriately for the person.

### CROSS-REFERENCE TO RELATED APPLICATIONS

The present application claims priority to U.S. Provisional Application No. 61/288,650 filed on Dec. 21, 2009 and is herein incorporated by reference in its entirety.

### GENERAL FIELD OF THE INVENTION

The exemplary embodiments herein relate generally to carriers for devices which extend outwardly from a person. More specifically, exemplary embodiments relate to carriers for percussion instruments.

### BACKGROUND OF THE EXEMPLARY EMBODIMENTS

For musical groups which incorporate movement into their performances, it is known for the percussion users to attach their instruments to their person in order to be able to play while moving. These groups may play while moving or may play in stationary setups which may frequently move or re-locate. The device which is used to attach the instrument to the user is commonly known as a ‘carrier’ and exists in several different styles.

Generally, the instrument is fastened to a plate which typically rests against the user's abdominal area. The plate is typically supported from above by connecting the plate with a pair of hooks that rest on the shoulders of the user. In some versions, a ‘T-bar’ design is placed across the chest area of the user and is used to connect the abdominal plate with the shoulder hooks. In other versions, the abdominal plate, hooks, and the connection between the plate and hooks is incorporated into a single element which resembles a ‘vest’. In these previous designs, the weight of the instrument is primarily distributed between the abdominal plate and the shoulder hooks. This typically causes the user to lean backwards in order to counteract the forces pulling them forwards and down. This can lead to poor posture, low mobility, bad performance technique, and pain in the shoulders and lumbar back area.

Other versions have attempted to counteract these forces by connecting the abdominal plate with another plate located in the upper-middle portion of the back (thoracic portion). These plates typically rest directly over the spine of the user and are designed to distribute some of the load from the instrument to the back of the user. In recent years it has become desirable to fit the carrier underneath the uniform jacket of the user (i.e. the carriers are typically close-fitting with the user) so that the carrier is not visible during a performance and the user's upper body resembles those of the other groups members who do not require a carrier. However, the previous designs for connecting the abdominal plate with the back plate have been difficult or impossible to fit underneath the user's jacket as they have extended away from the user. The comfort, weight, and entrance/exit into these carriers has also been problematic.

Further, in any of these prior designs, there is typically at least one support element that connects the abdominal plate to the shoulder hooks (or sometimes straps) and typically passes directly over the user's chest. This causes forward and downward forces on the shoulders of the user which can result in fatigue and discomfort. Also, the presence of an obstruction in front of the user can reduce their range of motion. For female users specifically, these support elements can obstruct their chest and cause discomfort or the inability to even wear the carrier and participate in the activity.

### SUMMARY OF THE GENERAL INVENTIVE CONCEPT

Exemplary embodiments provide a new type of carrier which distributes the weight of the instrument throughout the thoracic portion of the back. A pair of rigid members may be used to distribute the weight across the trapezius muscle of the user and wrap around the torso of the user in order to connect with an abdominal plate. The carrier may create a fulcrum between the abdominal plate and the portion of the rigid members across the thoracic portion of the back. The amount of force on the top of the trapezius muscle (shoulder area) is reduced and the resulting forces help to establish proper posture for the user and increase the range of motion, security of the instrument to the user, and overall comfort.

In an exemplary embodiment, there are no support members required directly between the abdominal plate and the shoulders. This allows the entire chest region of the user to remain free from obstruction. This increases the range of motion for the user as well as the overall comfort. Specifically for females, the embodiments can remove any uncomfortable support members which can obstruct their chest and cause discomfort or the inability to even wear the carrier and participate in the activity.

The rigid members may be form-fitting to the user so that a jacket or other uniform article may fit overtop the carrier. In some embodiments, a single piece may be used to distribute the weight throughout the thoracic portion of the back. A variety of adjustment features may be used to accommodate users of varying size. Disconnects and hinges may be provided to allow users to enter/exit the carrier. Some embodiments can be used with other devices that may extend outwardly from a person, including but not limited to video cameras.

### BRIEF DESCRIPTION OF THE DRAWINGS

In addition to the features mentioned above, other aspects of the exemplary embodiments of the present invention will be readily apparent from the following descriptions of the drawings and exemplary embodiments, wherein like reference numerals across the several views refer to identical or equivalent features, and wherein:

FIG. 1 is a perspective view of an exemplary embodiment;

FIG. 2 is a perspective view of an embodiment using hinged connections;

FIG. 3 is a perspective view of an embodiment using a singular element to cover the central portion of the user's back;

FIG. 4A is a front perspective view of an embodiment using a plurality of adjustment sleeves for fitting the carrier to the user;

FIG. 4B is a side perspective view of an embodiment using a plurality of adjustment sleeves for fitting the carrier to the user; and

FIG. 4C is a rear perspective view of an embodiment using a plurality of adjustment sleeves for fitting the carrier to the user.

### DETAILED DESCRIPTION OF EXEMPLARY EMBODIMENT(S)

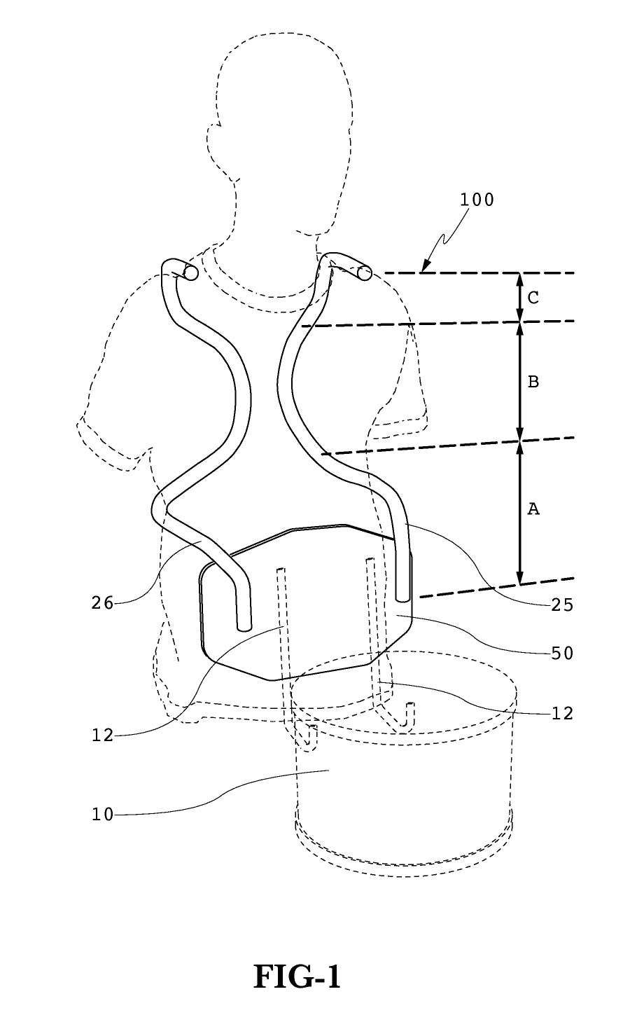

FIG. 1 provides a perspective view of an exemplary embodiment 100. Here, a drum 10 is attached to an abdominal plate 50 by using an attachment means 12. As is well known in the art, many different types of attachment means can be used with many different types of percussion instruments. Generally speaking, the specific attachment means 12 that is used may depend upon the manufacturer and the specific instrument (or other device) to be mounted to the abdominal plate 50. For the embodiments described herein, any type of attachment means 12 can be used. Examples of attachment means 12 include, but are not limited to: locking collars, locking sleeves, hangers, and mechanical fasteners. Of course, instruments other than singular drums can be used with any of the embodiments. By way of example and not by limitation, embodiments can be used to mount multiple drums (any type, including but not limited to snare, tenor/tom, and bass), marching bells, xylophone, vibraphone, marimba, timpani, or any other type of instrument. Further, any other device that extends outwardly from a person may be used, such as video cameras.

The embodiment shown 100 includes two rigid members 25 and 26 which are essentially mirror images of one another. Each of the rigid members 25 and 26 has three basic sections A, B, and C. Section A attaches to the abdominal plate 50 and passes laterally around the torso of the user. Section B traverses up the thoracic region of the back. In an exemplary embodiment, Section B is located mainly along the central portion of the middle trapezius muscle of the user, between the shoulder blades and the spinal column. Section C continues up the back of the user, moving toward the shoulders and ending on the top portion (shoulders) of the trapezius muscle.

In an exemplary embodiment, section B of the rigid members 25 and 26 would not cross over the spine of the user. In these embodiments, section B would travel primarily between the spine and shoulder blade of the user. It is within this B section that a portion of the weight of the drum 10 (or other attached item) is distributed throughout the thoracic portion of the user's back. Essentially, there may be a fulcrum between the abdominal plate 50 and the section B of the rigid members 25 and 26. By using this fulcrum, there may be less weight on the section A of the rigid members 25 and 26 and thus less downward force on the user.

It may be desirable for section A to wrap closely around the torso of the user so that there is a larger range of motion for the user and so that the carrier could fit underneath an article of clothing (uniform, jacket, etc.). Further, section A could rest against the oblique portion of the user's abdominal muscle to provide lateral stability to the carrier as the user moves.

It should be noted that each of the section A, B, and C of the rigid members 25 and 26 may be separate pieces that are attached to one another to create an overall rigid piece. Alternatively, the rigid members 25 and 26 may be singular continuous pieces without any physical separation for sections A, B, and C. In some embodiments, sections A, B, and C may be separate pieces and may slide into/out of each other at the separation points to allow for adjustment of the carrier to fit different-sized users.

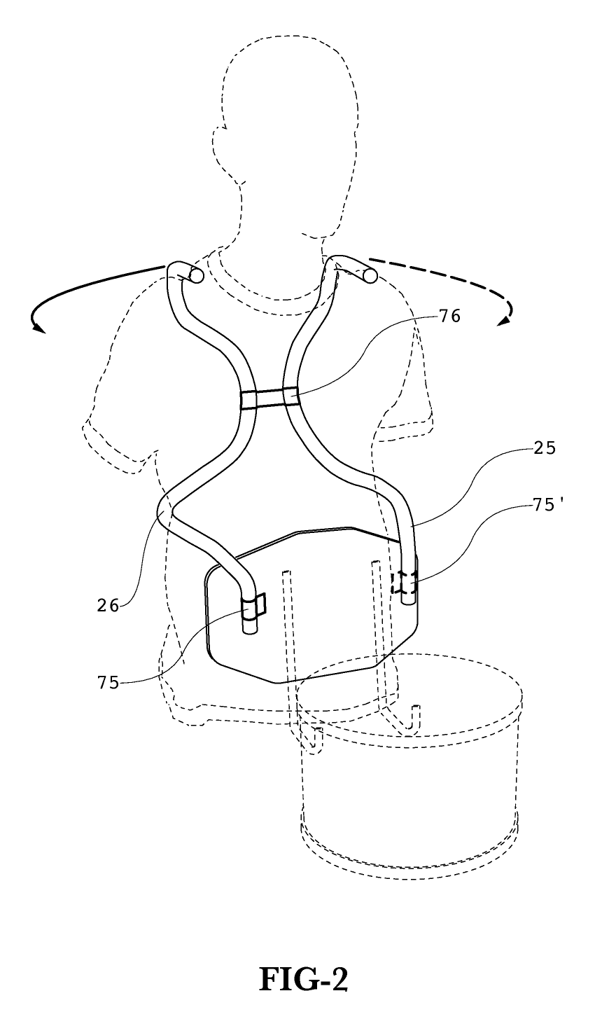

As shown in FIG. 2, to facilitate entry into the carrier, one or both of the members 25 and 26 may rotate between a closed and an open position. The connection with the abdominal plate 50 may allow for this rotation. Thus, in some embodiments one or both of the members 25 and 26 may open and close in a ‘butterfly wing’ type of rotation. Here, member 26 is attached to the abdominal plate using a hinge 75. Optionally, member 25 may be attached to the abdominal plate using an optional hinge 75′. The members 25 and 26 may be biased in the closed position, optionally by using a hinge that contains a spring. Alternatively, there may be no biasing but simply a latch, hook, or other retaining device that holds the members 25 and 26 in a closed position while the carrier is in use. Here, a latch 76 may be used to hold the members 25 and 26 in the closed position.

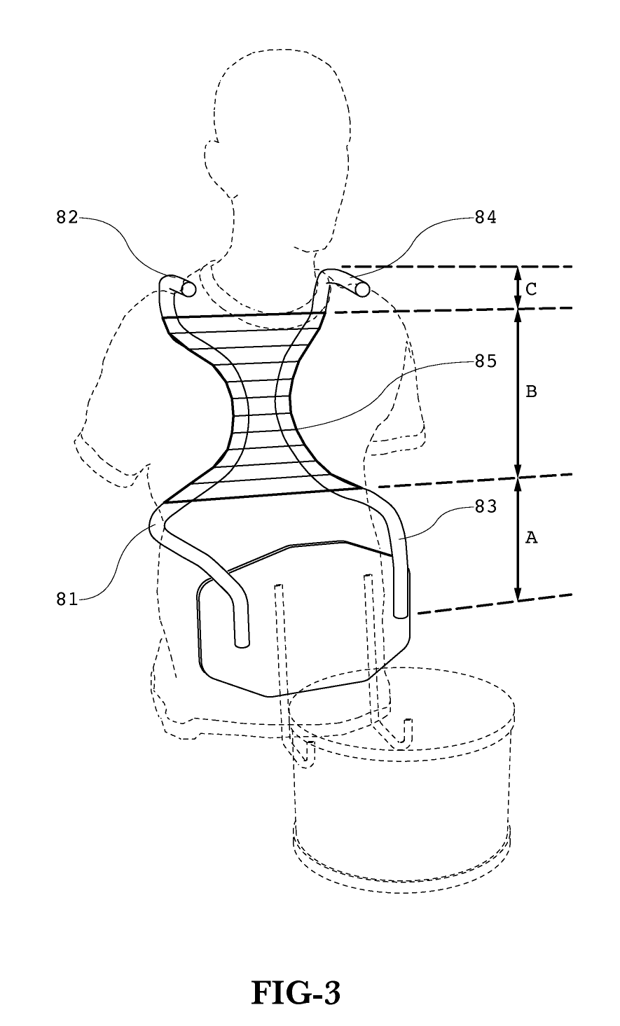

Alternative embodiments may combine the members 25 and 26 into a singular piece. As shown in FIG. 3, section A of this embodiment contains members 81 and 83, which may connect to the abdominal piece and move laterally towards the lower back portion of the user. As section B begins, the members may combine into a singular piece 85 which covers the thoracic portion of the user's back. This singular piece 85 may be metallic, plastic, composite, or fiberglass. This singular piece 85 could be adjustable or could be provided in a variety of sizes to fit different users. Section C may contain two members 82 and 84 which extend from the singular thoracic piece 85 to cover the shoulders of the user. The spacing of the section C members 82 and 84 may be adjustable to accommodate different shoulder widths of the various users. In this type of embodiment, member 81, member 83, or both members 81 and 83 may detach from the abdominal plate so that the user can enter the carrier. In some embodiments, member 81 may detach while member 83 may rotate to allow the user to enter.

With any embodiment, as the section A (or members 25 and 26 or members 81 and 83) wrap around the torso of the user there may be an adjustment point to allow for different-sized users. Thus, the width of the user (anterior to posterior dimension) can be accounted for by allowing the section A to elongate or shorten. The precise attachment point on the abdominal plate can also allow for an adjustment of the relative position of the abdominal plate and the section A of the members 25 and 26.

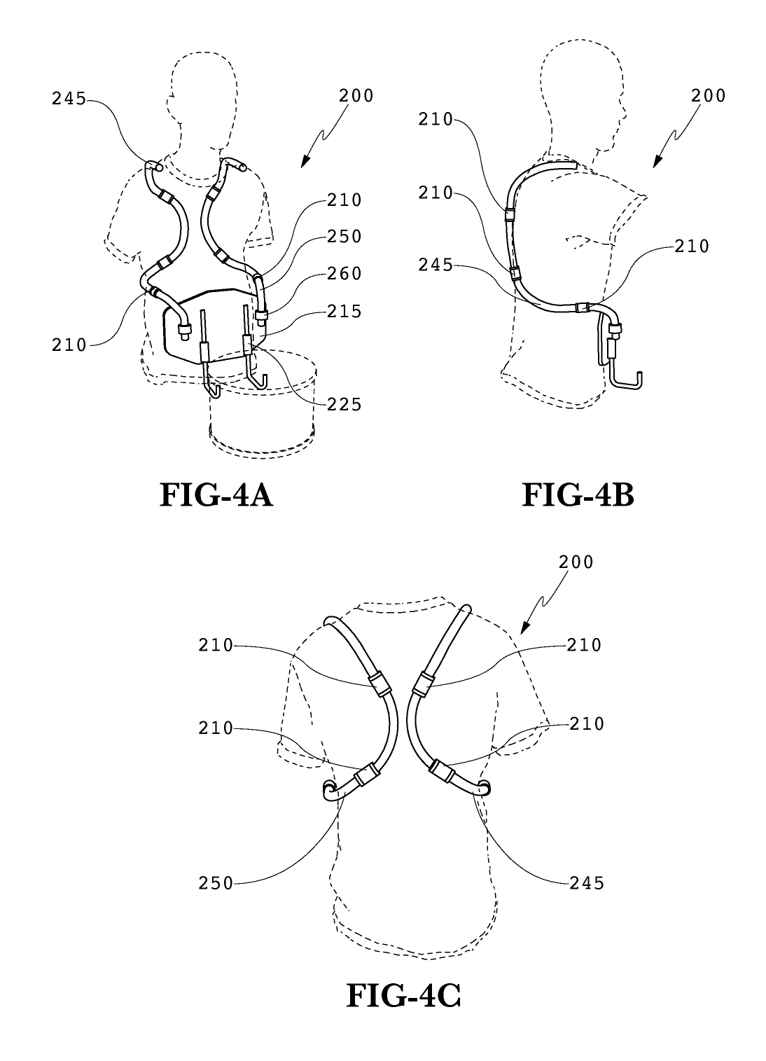

FIGS. 4A-4C provide perspective views of another embodiment of the carrier 200 which contains several adjustment points 210. Here, members 245 and 250 surround the user in a similar manner as the embodiments shown and described above. Here, several adjustment points 210 are located along the members 245 and 250 to permit the carrier 200 to be formed for the particular user's size, shape, and comfort. In an exemplary embodiment of the carrier 220, the members 245 and 250 may slide relative to one another and the adjustment points 210 may be locking collars which fix the members in place.

Also shown in this embodiment is an optional adjustable fastening point 260 which fastens the members 245 and 250 to the abdominal plate 215. Fastening point 260 may allow the members 245 and 250 to be fastened in a number of orientations relative to the abdominal plate 215, in order to accommodate the user. A locking collar could also be used for fastening point 260.

Here, the attachment means 225 is a pair of apertures, each one accepting a rigid member and tightening a mechanical fastener against the rigid member in order to hold the rigid member in place. Again, many different types of attachment means may be used with the various embodiments herein, depending on the device to be hung from the carrier and the particular manufacturer.

The rigid members can be made of any rigid or semi-rigid material including but not limited to: metal, composite, plastic, fiberglass, or wood. In some embodiments, the members may be heat-moldable plastics so that each carrier could be custom-fitted to the user. By applying heat to the members they can be reformed and/or bent to increase the comfort and fitting with the user.

While certain embodiments are described in detail above, the scope of the invention is not to be considered limited by such disclosure, and modifications are possible without departing from the spirit of the invention as evidenced by the following claims:

What is claimed is:

1. A carrier for use by a person to carry a device extending outwardly from said person, said carrier comprising:
an abdominal plate;
a first support member extending from the abdominal plate and around a portion of the waistline of the person, continuing up the back and along the thoracic portion of the person's back, and stopping on the top portion of the trapezius muscle of the person; and
a second support member extending from the opposing side of the abdominal plate as the first support member and around the waistline of the person, continuing up the back and along the thoracic portion of the person's back, and stopping on the top portion of the trapezius muscle of the person.

2. The carrier of claim 1 further comprising:
a hinge which attaches the first support members to the abdominal plate.

3. The carrier of claim 2 further comprising:
a hinge which attaches the second support members to the abdominal plate.

4. The carrier of claim 1 further comprising:
an adjustment point on the first and second support members, located near the person's waistline.

5. The carrier of claim 4 wherein:
the adjustment point is a locking collar.

6. The carrier of claim 1 further comprising:
an attachment means on the abdominal plate for attaching a device to extend outwardly from the person.

7. The carrier of claim 6 wherein:
the attachment means is a pair of apertures, each accepting a rigid member and tightening a mechanical fastener against the rigid member.

8. A harness for carrying a drum or the like on the front of a human user comprising:
a plate for receiving the drum or the like, adapted to bear against the abdomen of the user; and
a pair of rigid members attached to the plate, at least one of the rigid members rotatable from a closed position to an open position to be placed on the user, the rigid members each passing laterally around the torso of the user and co-acting to place a substantial amount of the weight of the drum or the like onto the dorsal thorax of the user.

9. The harness of claim 8 wherein:
each of the rigid members remain to one side of the spine.

10. The harness of claim 8 further comprising:
a latch which holds the rigid members in the closed position.

11. The harness of claim 8 further comprising:
a spring which biases the rigid members in the closed position.

12. The harness of claim 8 further comprising:
an adjustment point on the rigid members, located near the user's waistline.

13. The harness of claim 12 wherein:
the adjustment point is a locking collar.

14. The harness of claim 8 further comprising
a second pair of rigid members, connecting with the first pair at the dorsal thorax of the user and transferring a portion of the weight of the drum or the like onto the trapezius muscle of the user.

15. A device for mounting a drum on a human user, comprising:
a plate member, sized to be placed against the abdomen of the user; and
first and second tubular members, mirror-images of each other and having a first and second end, the first end of each tubular member mounted on the plate member, the second end of each tubular member sized and adapted to rest atop a shoulder of the user, and an intermediate portion of each tubular member sized and adapted to extend around the torso of the user.

16. The device of claim 15 wherein:
the first tubular member rotatingly opens from a closed position to an open position to encompass the torso of the user.

17. The device of claim 15 wherein:
the first and second tubular members rotatingly open from a closed position to an open position to encompass the torso of the user.

18. The device of claim 15 wherein:
the first and second tubular members have a removable connection with the plate member.

19. The device of claim 15 wherein:
an adjustment point on the first and second tubular members, located near the user's waistline.

20. The device of claim 19 wherein:
the adjustment point is a locking collar.
